(19) United States
(12) Patent Application Publication
(10) Pub. No.: US 2004/0162883 A1
(43) Pub. Date: Aug. 19, 2004

(54) Prioritization of real-time communication addresses

(76) Inventors: Peyman Oreizy, Kirkland, WA (US); Jordan L.K. Schwartz, Seattle, WA (US); Paul R. Erickson, Sammamish, WA (US); Andrew F. Boardman, Redmond, WA (US); Walter R. Smith, Seattle, WA (US); Deana R. Fuller, Seattle, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/368,712

(22) Filed: Feb. 14, 2003

(51) Int. Cl. G06F 15/16

(52) U.S. Cl. 709/207

(57) ABSTRACT

The present disclosure recites methods, systems, and computer program products for selecting an appropriate service provider for a real-time communication activity with a contact. Each of one or more contacts may have one or more real-time addresses corresponding to distinct service providers, and/or to particular real-time communication activities. Based on one or more criteria, a selection module prioritizes service providers for a requested real-time communication activity with a contact, producing a subset of prioritized service providers. From the subset, an appropriate real-time address associated with a specific service provider for a real-time communication activity may be selected to communicate with a particular contact.

### CROSS-REFERENCE TO RELATED APPLICATIONS

N/A

### BACKGROUND OF THE INVENTION

1. The Field of the Invention

The present invention relates to real-time communication, particularly with respect to methods, systems, and computer program products for selecting an appropriate service provider for a given real-time electronic communication activity through a single interface.

2. The Relevant Technology

The popularity of the Internet and satellite-based technologies has enhanced the way people communicate with each other by allowing users quick and easy access to a virtually endless sea of communication methods. Any given person may now contact another person with greater or lesser immediacy using various media, including the World Wide Web, electronic mail (email), satellite-based or Internet-based telephony, video conferencing, and instant text messaging. These methods allow people to stay in touch with each other around the globe, and to access information on an almost limitless variety of subjects, in some cases instantly.

Just as the methods by which people may contact each other have expanded, so too have the numbers of addresses by which people can be reached. Multiple addresses can impede communication. For example, when email was introduced initially, users could only send email to other users who had the same software, or were on the same email network. Similarly, with the advent of instant text or video messaging, typically only those users who subscribe to a specific instant messaging service using the same software may contact each other via that specific messaging service's network and user interface. Thus, as in the prior case with email, users of real-time communications have had to install service specific software, and in many cases, subscribe to multiple instant messaging service providers, each of which requires a separate real-time address.

Of course, email has now moved to a common system where only one contact address is needed to communicate with a user on a different network. Users can send email back and forth to each other without downloading each respective user's proprietary software or maintaining multiple email addresses. In contrast, real-time communication protocols, such as instant messaging services, continue to rely on exclusive networks and exclusive software for inter-user communication.

As a result, instant message users subscribing to one network cannot send real-time text or video messages to users of another network, and vice versa, without installing software specific to the other network. Users, therefore, install a separate user interface for each service provider and gain a corresponding real-time address for each. Accordingly, users wishing to contact other users through different instant messaging networks must keep a separate user interface open for each ongoing message session, wasting valuable computer display real estate.

With the continued grown in the popularity of the Internet and satellite-based communications, the number of devices communicating on these media have increased as well. Devices such as mobile phones, pagers personal digital assistants, televisions, and the like, increasingly are used to communicate with others on the Internet. With the growth of device types, it is becoming more probable that two users who wish to engage in a messaging session will not be using a convention computer. For example, one user may be accessible by a mobile phone, whereas the second uses a desktop computer.

As might be expected, the multiple numbers of devices per user compounds the complexity of contacting that user over different, software-exclusive networks. For example, just as a contact may have several email addresses on different servers (e.g., someone@microsoft.com, someone@yahoo.com), and several telephone numbers (local, toll free, mobile, facsimile, etc.), a user also may have several different real-time messaging addresses, depending, for example, on the device where the contact may be reached. As a general rule, a user's selection of a particular real-time messaging address has been tied to the user's selection of a particular user interface for a particular service provider, without any prioritization of addresses based on information about a contact, a service provider, or user's computing environment.

No known messaging service offers support for real-time communication with one or more contacts using any of one or more real-time addresses and a single user interface, or prioritization of real-time addresses for different service providers. Moreover, no known messaging system allows for selecting an appropriate real-time communication address given a plurality of choices.

Accordingly, what is desired are systems, methods, and computer program products that allow for selecting an appropriate service provider for a given real-time electronic communication activity through a single interface.

### BRIEF SUMMARY OF THE INVENTION

The present invention relates to methods, systems, and computer program products for selecting an appropriate service provider through a single interface for a given real-time electronic communication activity. Upon receiving a request for a real-time electronic communication activity, potentially directed to multiple contacts, each potentially having multiple real-time addresses for the requested activity, an inquiry is made to one or more service providers to determine which support the requested activity for the one or more contacts. Various types of contacts are described in the detailed description that follows this summary.

For example, a contact's real-time address for a telephone may support only text messaging, whereas the contact's real-time address for a computer may support both text and audio/video messaging. If an audio/video communication activity is requested, the service provider for the telephone real-time address would not indicate that audio/video instant messages were supported. Independent of the requested communication activity, a contact may not be available at a particular real-time address, such as when a user has logged off or shut down a computer. From the inquiry, a subset of service providers is identified.

Selecting a particular service provider from the subset is based on one or more prioritization values. For example, a contact may express a preference for being contacted at a specific real-time address, or a user may express a preference for a particular service provider, or a preference may be established for a user's computing system, and the like. Additional examples of and details with respect to prioritization values are described below.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. These drawings depict only typical embodiments of the invention and are therefore not to be considered limiting of its scope. The invention will be described and explained with additional specificity and detail through the use of the accompanying drawings in which:

FIG. 1 illustrates a prior art depiction of a computer screen having several applications open, including a plurality of instant message applications.

FIG. 2 illustrates an example contact with various addresses, including real-time addresses.

FIG. 3 illustrates a flowchart depicting an example implementation of the present invention.

FIG. 4 illustrates an example diagram of the present invention where a user wishes to communicate in real-time with a contact.

FIG. 5 illustrates a representation between a user and a potential contact.

FIG. 6 illustrates a second example flow chart relating functional steps and non-functional acts of the present invention.

FIG. 7 illustrates an example system that provides a suitable operating environment for the present invention.

### DETAILED DESCRIPTION OF THE PREFERRED EMBODIMENTS

The present invention extends to methods, systems, and computer program products for selecting an appropriate service provider for a given real-time electronic communication activity through a single interface. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

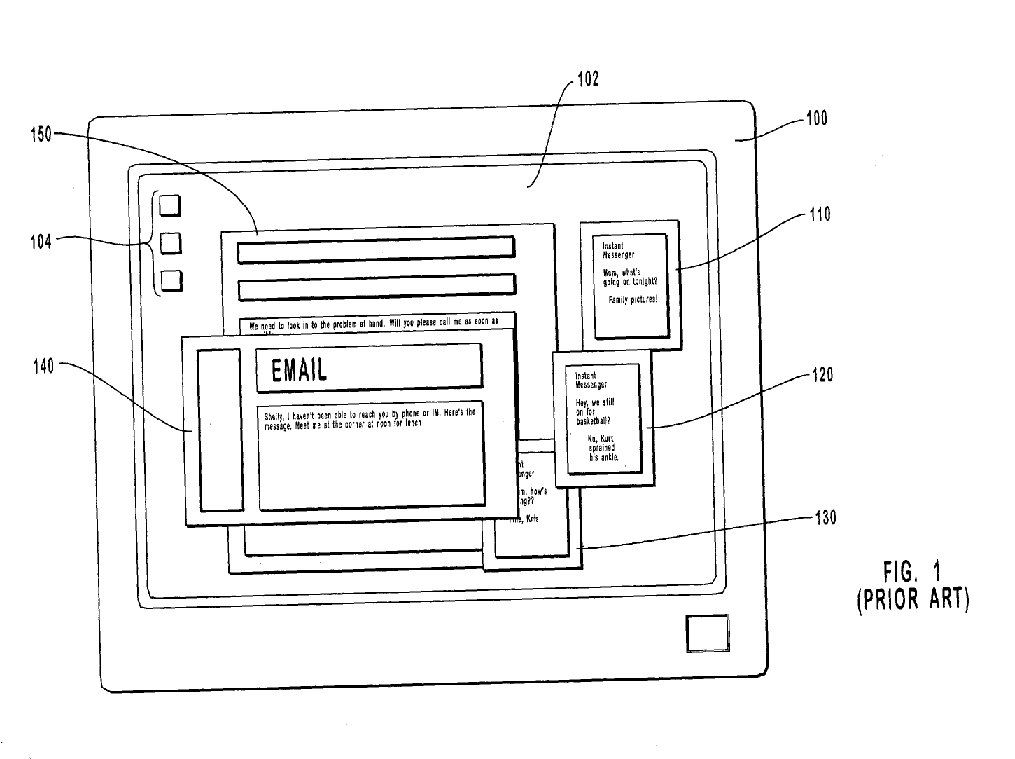

FIG. 1 illustrates a prior art system where monitor 100 has a desktop screen 102 with multiple open applications and application icons 104 shown in the context of a graphical user interface (GUI). FIG. 1 shows at least one problem in the prior art from having separate user interfaces for real-time communication with contacts using different service providers. As depicted, word processing application 150 is obscured by email interface 140 and instant message interface 130. Instant message interface 130 is itself obscured by email interface 140 and instant message interface 120. Instant message interface 110 also occupies a portion the desktop screen 102 real estate. As a result, for a user to monitor the instant message conversations 110, 120, and 130, as well as to reference the word processing document 150 or email 140, the user is forced to toggle between each of the different interfaces.

In the case of FIG. 1, a user may be required, alternatively, to selectively arrange or resize the various interfaces on the screen in order to monitor the interfaces 110, 120, 130, 140, and 150 at once. While GUIs are able to arrange multiple interfaces for simultaneous viewing, each is generally required to be reduced in size, limiting the amount of information that can be viewed at one time. Accordingly, it should be appreciated that multiple interfaces can be a burden to both system resources as well as the user, and therefore, to the nature of real-time communication itself.

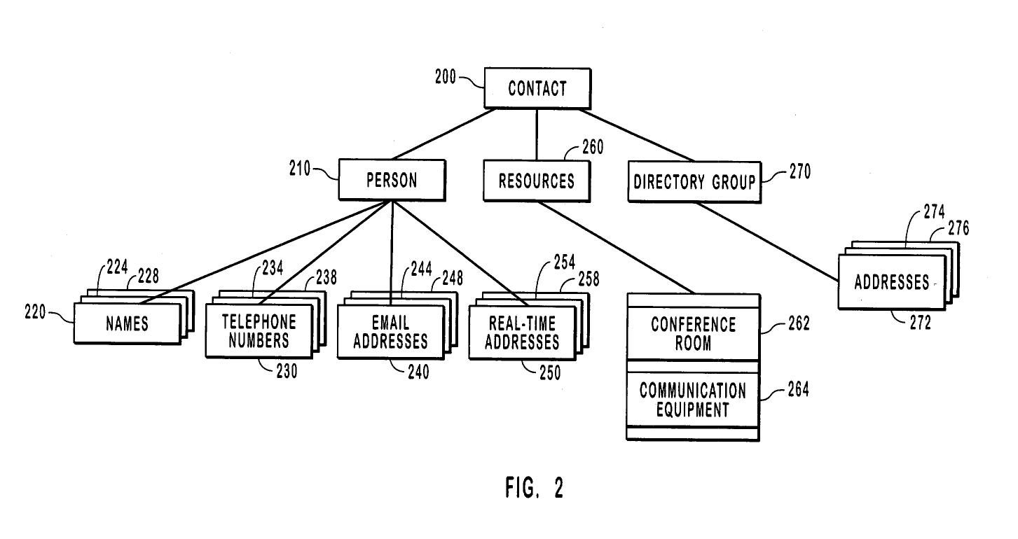

FIG. 2 illustrates an example contact 200 that may participate in a real-time communication activity. As used in this application, “contact” should be interpreted broadly to encompass any entity capable of sending, receiving, or otherwise participating in real-time communication. Accordingly, it should be emphasized that the types of contacts shown in FIG. 2 are exemplary only.

As shown, contact 200 may represent a person 210, a set of resources 260, a directory group 270, etc. A person 210, for example, may be represented by a collection of names 220, including individual names 224 and 228; a set of telephone numbers 230, including individual telephone numbers 234 and 238, whether by satellite, Internet, or standard telephony; a set of email addresses 240, including individual email addresses 244 and 248; and a set of real-time addresses 250, including individual real-time addresses 254 and 258, etc. While FIG. 2 illustrates one common way of representing a person 210 as a contact, it certainly is not an exhaustive list.

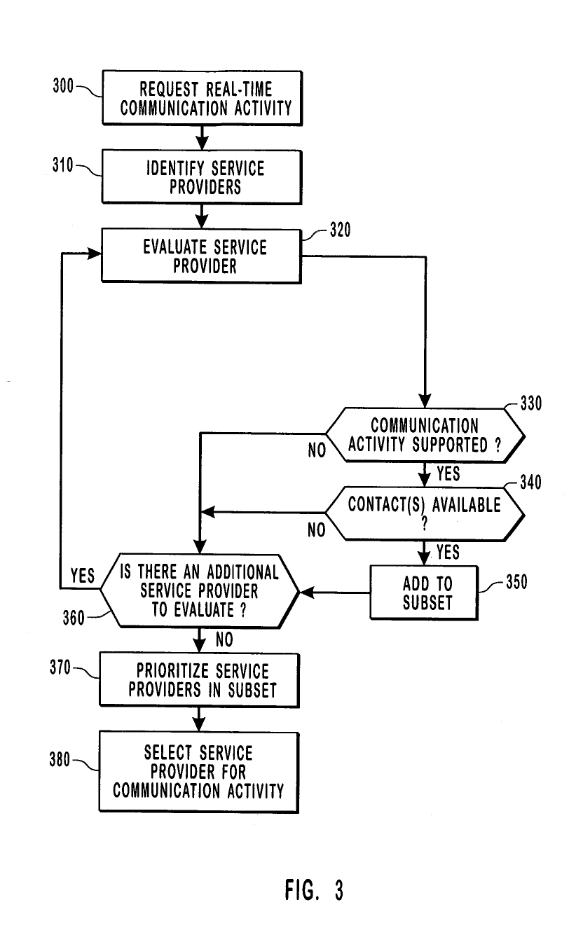

A contact may have multiple real-time addresses for a variety of reasons, such as the desire to communicate with others on different service providers, for different devices where the contact may be reached, for different types of communication activities, and so on. Referring back to the discussion of FIG. 1 above, each distinct service provider typically requires a separate user interface. The present invention, however, allows for selecting an appropriate service provider for a given real-time electronic communication activity through a single interface. Part of the selection process includes prioritizing service providers based on prioritization values associated with a contact, a service provider, or a client computing system. This prioritization is described in greater detail below, with reference to FIGS. 3-5.

As further shown in FIG. 2, a contact 200 also may represent a set of resources 260, such as a conference room address 262, and communication equipment address 264. In this particular example, the resources may be used for scheduling, for video or audio conferencing, or for any other purpose involving real-time communication activities. A contact 200 can also take the form of a directory group 270. Directory group 270 contains a plurality of addresses (272, 274, 276) representing other contacts, such as electronic addresses for employees of a company, members of a workgroup, friends or acquaintances (whether personal or business), etc. When a user sends a message to a directory group 270, the message is routed to the addresses of each of the members (272, 274, 276) of the directory group 270.

FIG. 3 illustrates a flow chart for a selection module implementing the present invention between one user and one contact, where a contact has a plurality of real-time addresses. One should note for clarity that some of the Figures depict the case of one user communicating in real-time with one contact. The invention, however, should not be construed as limited to the single contact case, which may be readily practiced by a user communicating with a plurality of contacts, and vice versa.

With specific reference to FIG. 3, a user may request (300) a real-time communication activity with a contact having multiple real-time addresses. The real-time communication activity may be any or a combination of, for example, an instant message, chat, videoconference, a game, and the like, including audio communication, text communication, video communication, etc.

Since the contact may have multiple real-time addresses the selection module identifies (310) one or more potential service providers, such as those associated with one of the contact's real-time addresses. It should be appreciated that, although in one embodiment the selection module may inquire of the capabilities of service providers associated with a contact's real-time addresses, selection may not necessarily be limited to those providers. For example, a selection module may inquire of several different service providers—to which the contact may or may not be subscribed—to first identify potential service providers.

Then, in response to a request for a real-time communication activity directed to one or more contacts, each having one or more real-time addresses, the selection module determines which of one or more service providers support the requested real-time communication activity for each of the one or more contacts. That is, the selection module evaluates (320) a service provider from those that have been identified. In the evaluation, the selection module asks (330) the service provider whether the provider supports the requested real-time communication activity for the contact. If the provider does not support the activity, the selection module's inquiry ends for that provider, and the selection continues with any additional provider (360, 320), if one is available.

If the provider supports the requested real-time communication activity, the selection module inquires (340) whether the requested contact is available for the requested real-time activity on the service provider. If the contact is not available for the activity, the selection module's inquiry ends for that provider, and the selection continues with any additional provider (360, 320), if any additional service providers remain. If the provider supports (330) the requested communication activity, and the contact is available (340) for the activity, the selection module adds (350) the service provider to a subset of service providers that support the requested real-time communication activity, and processing continues with any additional or next service provider (360, 320).

Once all of the identified service providers have been considered (i.e., there is no additional (360) service provider), the selection module prioritizes (370) the service providers in the subset. The prioritization may be based on prioritization values for the contact, the service provider being prioritized, and/or the client system requesting the real-time communication. These prioritization values may include such characteristics as time of day, the user's or contact's communication preferences for a certain address or activity, service provider cost concerns for an activity, quality of service, available bandwidth, historical data, capabilities of the contact and client system, presence data associated with the contact or a user of the client system such as online status, location, etc., policies to which the client system is subject (e.g., an information technology department may specify certain preferences or requirements), and/or any other value useful in establishing a relative priority for one service provider over another.

The prioritization values may account for preferences due to prior cost agreements or bandwidth requirements. For example, an organization may mandate that, within the hours of 2PM and 5PM, video messaging services should be routed only through a particular service provider, or that for all audio communications activities resulting in a telephone call, long distance carrier Z should be the preferred service provider based on negotiated or known rates. Similarly, based on historical data, a particular service provider may be preferred for video messaging during weekday business hours since experience indicates higher bandwidth is typically available from that service provider during that time. Consequently, several factors may be considered during prioritization. Once the module has prioritized the subset of service providers, the module selects (380) a service provider for the communication activity.

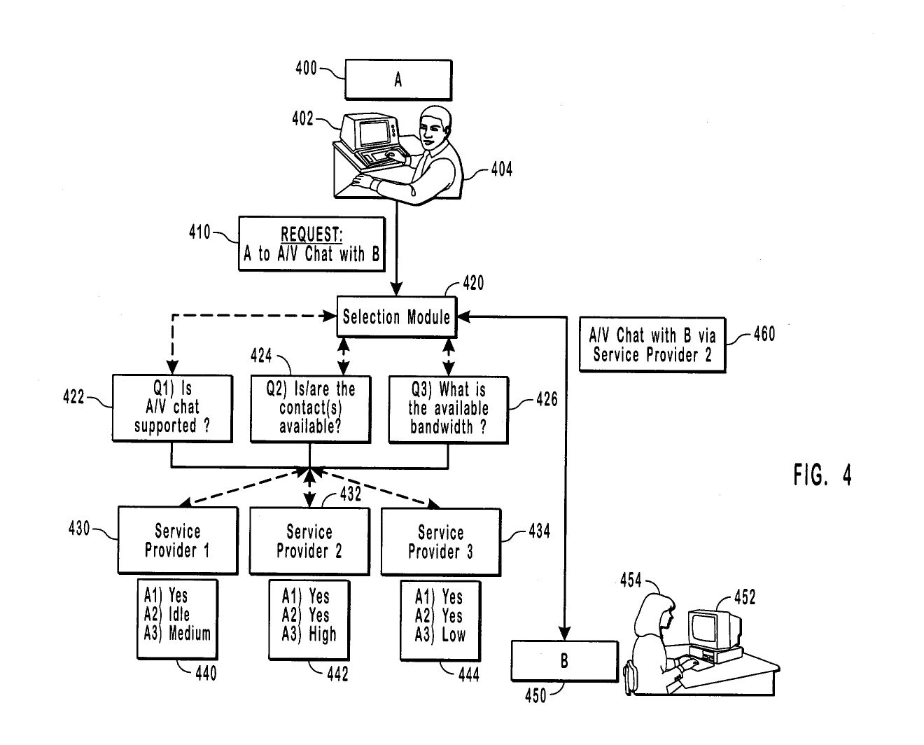

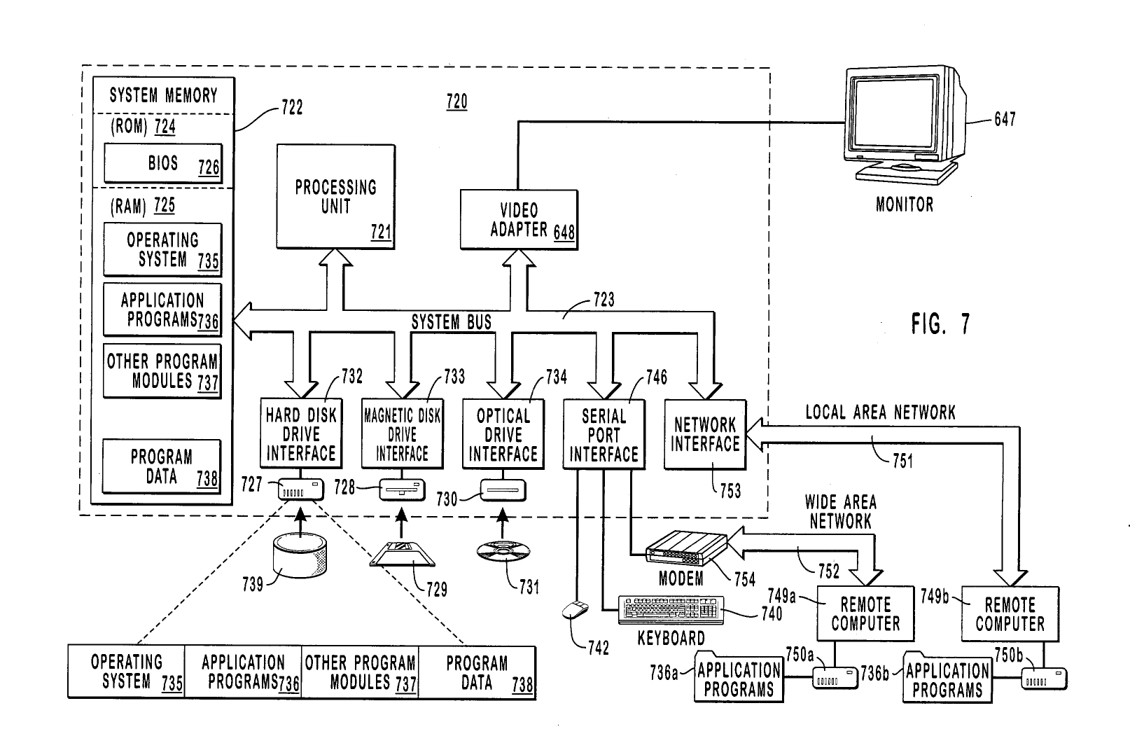

FIG. 4 illustrates an example diagram of the present invention. In FIG. 4, user A (400) desires to communicate through an audio/video (A/V) instant messaging service with contact B (450). In this example, person (404) and client computing system (402) represent user (400); similarly, person (454) and client computing system (452) represent contact B (450). To establish an audio/video instant messaging channel (460), between person A (404) and person B (454), person A (404) first initiates a request (410) via the client computing system. It should be noted that the client computing system might be any computing system described in connection with FIG. 7 or any other computing system capable of real-time communication activities.

One of ordinary skill in the art will appreciate that audio and video real-time communications will require, generally, a greater service provider bandwidth. In FIG. 4, the selection module (420) is shown inquiring of at least three different service providers (i.e., 430, 432, and 434) three questions: 1) Is audio/video instant messaging (IM) communication supported (422) by this service provider? If so, 2) is/are the contact(s) (person B (454)) currently available (424) for this communication activity? And, if so 3) what bandwidth is currently available (426)?

Each service provider responds to the selection module (420) with an answer set (440, 442, and 444). Note in particular that the bandwidth question corresponds to a prioritization value. This information may be obtained from various sources, including the service provider itself, historical data maintained at the client computing system, setup information when service provider was installed, etc.

As shown, service provider 1 (430) replies (440) that it does support audio/visual instant message communication, the contact (in this case person B 454) is currently idle, and that the current bandwidth capacity is medium. (The bandwidth may also be expressed as a bit rate or in some other form that allows for relative comparisons to be made.) Service provider 2 (432) replies (442) that it also supports audio/visual instant message communication, that the contact is available for communication, and that the service provider can offer high bandwidth for the requested activity. Service provider 3 (434) replies (444) that it too supports audio/visual instant message communication, that the subscriber is available, but that it can only offer low bandwidth for the requested activity.

With this information, selection module (420) prioritizes the potential service providers for audio/video instant message communication between person A (404) and person B (454). If bandwidth were the only consideration, service provider 2 (432) would be prioritized first. This prioritization is based in part on the fact that audio/video communication will require, generally, greater bandwidth from a service provider, and that service provider 2 (432) has the greatest bandwidth to offer at the present time. While it is not shown explicitly in FIG. 4, person A (402) has subscribed to at least service provider 2 (432).

Alternatively, cost may be another consideration for the prioritization. Perhaps service provider 2 (432) is extremely expensive, whereas service provider 1 (430) and service provider 3 (434) are more moderately priced. Although service provider 2 (432) may be preferred for performance, service provider 1 (430) may be preferred for value. Of course, those of skill in the art will recognize that many combinations of prioritization values are possible and that the present invention is not necessarily limited to any particular prioritization scheme.

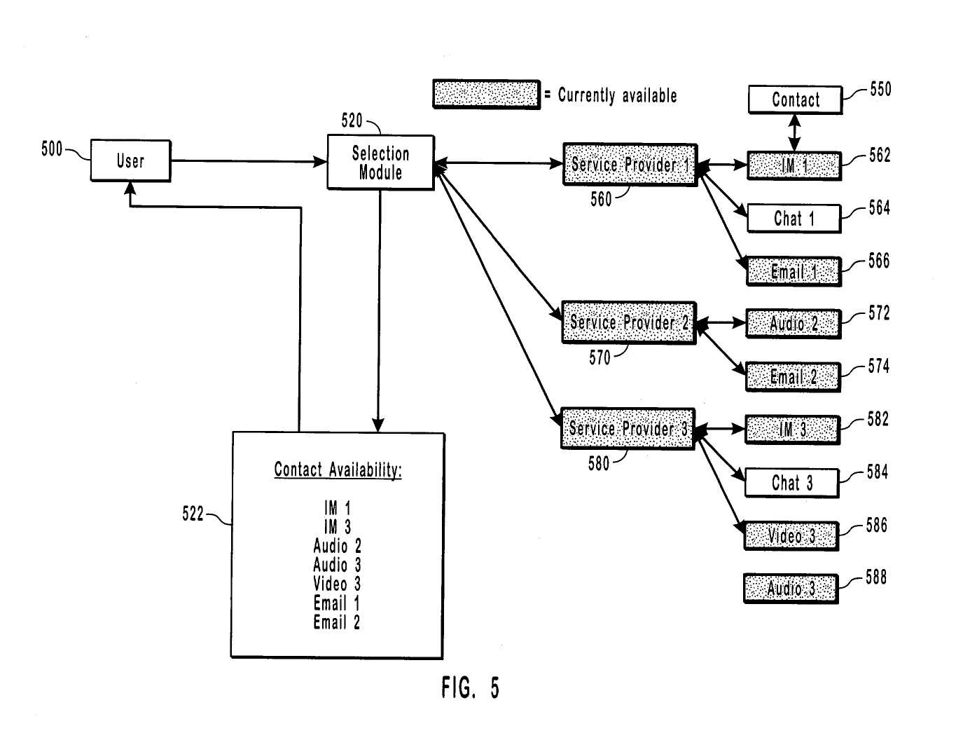

FIG. 5 illustrates another embodiment of the present invention where user 500 has installed on its system service providers 1 (560), 2 (570), and 3 (580). Contact 550 also has installed on its system service providers 1 (560), 2 (570), and 3 (580). For contact 550, service provider 1 (560) supports instant messaging 1 (IM 1) (562), chat 1 (564), and email 1 (566). Service provider 2 (570) supports audio 2 (572), and email 2 (574). Service provider 3 (580) supports IM 3 (582), chat 3 (584), video 3 (586), and audio 3 (588).

User 500 may wish to communicate with contact 550 and so must engage selection module 520 to determine an appropriate service provider, based on, for example, the real-time addresses that user 500 maintains for contact 550. Selection module 520 queries service provider 1 (560), service provider 2 (570), and service provider 3 (580), to find out whether they support one or more requested real-time communication activities for contact 550, and whether contact 550 is currently available. Selection module 520 receives a response from each service provider (i.e., 560, 570, and 580) that contact 550 is available on IM 1 (562), IM 3 (582), audio 2 (572), audio 3 (588), video 3 (586), email 1 (566), and email 2 (574). Contact availability 522 identifies supported communication activities and the corresponding service providers, subject to the availability of contact 550.

Selection module 520 prioritizes the results for selection. As previously stated, this prioritization may be based on many factors, such as factors associated with the contact, the service provider, the client system, including the user's 500 preference for communication, the contact's preference for communication 550, prior cost arrangements with certain service providers, availability of future subscription, quality of service, presence data, device capabilities, time of day, organization rules, etc., or some combination thereof.

A sample priority heuristic for the prioritization shown in contact availability 522 could involve instructions such as: 1) bias real-time communication toward instant text messaging due to bandwidth considerations; 2) bias audio or video real-time communications to service provider 2 due to cost considerations; 3) use service provider 3 if no other services or service providers are available; and 4) use email if no other real-time services are available. Additionally, the selection module 520 may place services not found on user 500 (i.e., services on a service provider other than service provider 1 (560), service provider 2 (570), or service provider 3 (580)) in the contact availability 522 in the event user 500 may wish to subscribe to a new service provider. Perhaps, for example, the selection module performs an Internet search or a search of some other electronic database for real-time address for contact 550.

The present invention also may be described in terms of methods comprising functional steps and/or non-functional acts. The following is a description of acts and steps that may be performed in practicing the present invention. Usually, functional steps describe the invention in terms of results that are accomplished, whereas non-functional acts describe more specific actions for achieving a particular result. Although the functional steps and non functional acts may be described or claimed in a particular order, the present invention is not necessarily limited to any particular ordering or combination of acts and/or steps.

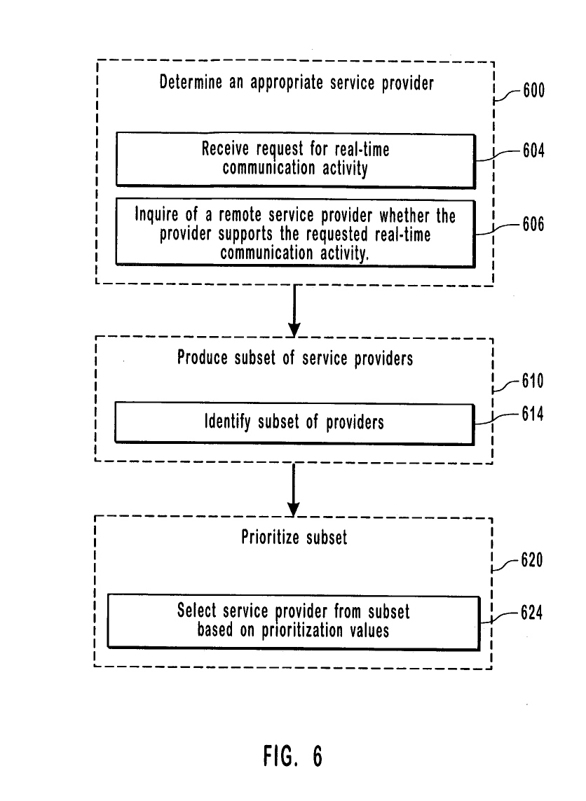

FIG. 6 shows example acts and steps for methods of processing real-time communication requests in accordance with the present invention. A step for determining (600) which of one or more service providers support a requested real-time communication activity may include the specific act of receiving (604) a request for a real-time communication activity directed to one or more contacts and a specific act of inquiring (606) of the one or more remote service providers to determine which support the requested real-time communication activity. A step for producing (610) a subset of the one or more service providers determined to support the requested real-time communication activity may include the specific act of identifying (614) a subset of service providers that support the requested real-time communication activity. Finally, a step for prioritizing (620) the subset of one or more service providers for selection may include the specific act of selecting (624) at least one service provider from the requested real-time communication activity from the subset based on a set of one or more prioritization values. While the present invention is not necessarily constrained by the order shown in FIG. 6, one embodiment of the present invention may operating according to this order.

FIG. 7 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

With reference to FIG. 7, an exemplary system for implementing the invention includes a general-purpose computing device in the form of a conventional computer 720, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory includes read only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disk drive 728 for reading from or writing to a removable magnetic disk 729, and an optical disc drive 730 for reading from or writing to removable optical disc 731 such as a CD ROM or other optical media. The magnetic hard disk drive 727, magnetic disk drive 728, and optical disc drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disc 731, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 739, magnetic disk 729, optical disc 731, ROM 724 or RAM 725, including an operating system 735, one or more application programs 736, other program modules 737, and program data 738. A user may enter commands and information into the computer 720 through keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 is connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a computing system that supports one or more real-time electronic communication activities with one or more contacts through one or more service providers having separate interfaces, a method of selecting an appropriate service provider for a given real-time electronic communication activity through a single interface, the method comprising acts of:
receiving a request for a real-time electronic communication activity directed to one or more contacts, each having at least one real-time address for at least one real-time electronic communication activity;
inquiring of one or more service providers to determine which support the requested real-time electronic communication activity for each of the one or more contacts to which the requested real-time electronic communication activity is directed;
identifying a subset of the one or more service providers that support the requested real-time electronic communication activity; and
selecting from the identified subset, at least one service provider for the requested real-time electronic communication activity for at least one contact, wherein the selection is based at least in part on a set of one or more prioritization values that are associated with at least one of (i) the at least one contact, (ii) the at least one service provider, and (iii) a client computing system through which the requested real-time electronic communication activity occurs.

2. The method of claim 1, wherein selection is based on one or more prioritization values associated with the at least one contact, the one or more prioritization values comprising a user's preference for real-time communication with the at least one contact.

3. The method of claim 1, wherein selection is based on one or more prioritization values associated with the client computing system, the one or more prioritization values comprising the client computing system's capabilities for real-time communication with the contact.

4. The method of claim 1, wherein selection is based on one or more prioritization values associated with the at least one contact, the one or more prioritization values comprising the at least one contact's preference for real-time communication.

5. The method of claim 1, wherein contact includes at least one of a person, a resource, and a group.

6. The method of claim 1, wherein selection is based on one or more prioritization values associated with the at least one contact, the one or more prioritization values comprising a service provider preference for the at least one contact.

7. The method of claim 6, wherein the one or more prioritization values further comprises prioritization values for at least one of, time of day, a user's or the at least one contact's presence information, the requested real-time communication activity, and service provider capabilities.

8. The method of claim 1, wherein the requested real-time communication activity comprises, at least one of, audio, video, and textual real-time communication.

9. The method of claim 1, wherein the one or more prioritization values comprise prioritization values for at least one of quality of service, the contact's online status, and service costs for different real-time communication activity types.

10. The method of claim 9, wherein quality of service comprises at least one of available bandwidth, total service provider bandwidth, levels of encryption, and historical data for previous real-time communication.

11. The method of claim 1, wherein selection is based on one or more prioritization values associated with the client computing system, the one or more prioritization values comprising at least one of time of day and service provider preference.

12. In a computing system that supports one or more real-time electronic communication activities with one or more contacts through one or more service providers having separate interfaces, a method of selecting an appropriate service provider for a given real-time electronic communication activity through a single interface, the method comprising the steps for:
in response to a request for a real-time communication activity directed to one or more contacts, each having one or more real-time addresses, determining which of one or more service providers support the requested real-time communication activity for each of the one or more contacts;
producing a subset of the one or more service providers, the subset including each of the one or more service providers determined to support the requested real-time communication activity for the one or more contacts; and
prioritizing the subset of one or more service providers for selection, wherein the prioritization considers one or more prioritization values associated with at least one of the one or more contacts, each service provider in the subset, and a client system that requested the real-time communication activity.

13. The method of claim 12, wherein the step for prioritizing is based at least in part on a user's preferences for the requested real-time communication activity.

14. The method of claim 12, wherein the step for prioritizing is based at least in part on the one or more contacts' preferences for the requested real-time communication activity.

15. The method of claim 12, wherein the step for prioritizing is based at least in part on the client system's capabilities for real-time communication with the contact.

16. The method of claim 12, wherein the step for determining which of one or more service providers support the requested real-time communication activity for each of the one or more contacts comprises an act of inquiring of the one or more service providers to make the determination.

17. The method of claim 12, wherein the step for producing a subset of the one or more service providers comprises an act of identifying a subset of the one or more service providers that support the requested real-time electronic communication activity.

18. The method of claim 12, wherein the step for prioritizing the subset of one or more service providers for selection comprises an act of selecting from the subset, at least one service provider based at least in part on the one or more prioritization values.

19. For a computing system that supports one or more real-time electronic communication activities with one or more contacts through one or more service providers having separate interfaces, a computer program product comprising a computer readable medium carrying computer executable instructions that implement a method of selecting an appropriate service provider for a given real-time electronic communication activity through a single interface, the method comprising acts of:
receiving a request for a real-time electronic communication activity directed to one or more contacts, each having at least one real-time address for at least one real-time electronic communication activity;
inquiring of one or more service providers to determine which support the requested real-time electronic communication activity for each of the one or more contacts to which the requested real-time electronic communication activity is directed;
identifying a subset of the one or more service providers that support the requested real-time electronic communication activity; and
selecting from the identified subset, at least one service provider for the requested real-time electronic communication activity for at least one contact, wherein the selection is based at least in part on a set of one or more prioritization values that are associated with at least one of (i) the at least one contact, (ii) the at least one service provider, and (iii) a client computing system through which the requested real-time electronic communication activity occurs.

20. The computer program product of claim 19, wherein selection is based on one or more prioritization values associated with the at least one contact, the one or more prioritization values comprising a user's preference for real-time communication with the at least one contact.

21. The computer program product of claim 19, wherein selection is based on one or more prioritization values associated with the client computing system, the one or more prioritization values comprising the client computing system's capabilities for real-time communication with the contact.

22. The computer program product of claim 19, wherein selection is based on one or more prioritization values associated with the at least one contact, the one or more prioritization values comprising the at least one contact's preference for real-time communication.

23. The computer program product of claim 19, wherein contact includes at least one of a person, a resource, and a group.

24. The computer program product of claim 19, wherein selection is based on one or more prioritization values associated with the at least one contact, the one or more prioritization values comprising a service provider preference for the at least one contact.

25. The computer program product of claim 24, wherein the one or more prioritization values further comprises prioritization values for at least one of, time of day, a user's or the at least one contact's presence information, the requested real-time communication activity, and service provider capabilities.

26. The computer program product of claim 19, wherein the requested real-time communication activity comprises, at least one of, audio, video, and textual real-time communication.

27. The computer program product of claim 19, wherein the one or more prioritization values comprise prioritization values for at least one of quality of service, the contact's online status, and service costs for different real-time communication activity types.

28. The computer program product of claim 27, wherein quality of service comprises at least one of available bandwidth, total service provider bandwidth, levels of encryption, and historical data for previous real-time communication.

29. The computer program product of claim 19, wherein selection is based on one or more prioritization values associated with the client computing system, the one or more prioritization values comprising at least one of time of day and service provider preference.

30. For a computing system that supports one or more real-time electronic communication activities with one or more contacts through one or more service providers having separate interfaces, a computer program product comprising a computer readable medium carrying computer executable instructions that implement a method of selecting an appropriate service provider for a given real-time electronic communication activity through a single interface, the method comprising the steps for:
in response to a request for a real-time communication activity directed to one or more contacts, each having one or more real-time addresses, determining which of one or more service providers support the requested real-time communication activity for each of the one or more contacts;
producing a subset of the one or more service providers, the subset including each of the one or more service providers determined to support the requested real-time communication activity for the one or more contacts; and
prioritizing the subset of one or more service providers for selection, wherein the prioritization considers one or more prioritization values associated with at least one of the one or more contacts, each service provider in the subset, and a client system that requested the real-time communication activity.

31. The computer program product of claim 30, wherein the step for prioritizing is based at least in part on a user's preferences for the requested real-time communication activity.

32. The computer program product of claim 30, wherein the step for prioritizing is based at least in part on the one or more contacts' preferences for the requested real-time communication activity.

33. The computer program product of claim 30, wherein the step for prioritizing is based at least in part on the client systems capabilities for real-time communication with the contact.

34. The computer program product of claim 30, wherein the step for determining which of one or more service providers support the requested real-time communication activity for each of the one or more contacts comprises an act of inquiring of the one or more service providers to make the determination.

35. The computer program product of claim 30, wherein the step for producing a subset of the one or more service providers comprises an act of identifying a subset of the one or more service providers that support the requested real-time electronic communication activity.

36. The computer program product of claim 30, wherein the step for prioritizing the subset of one or more service providers for selection comprises an act of selecting from the subset, at least one service provider based at least in part on the one or more prioritization values.
